(19) United States
(12) Patent Application Publication
(10) Pub. No.: US 2024/0246442 A1
(43) Pub. Date: Jul. 25, 2024

(54) INFORMATION PROCESSING METHOD

(71) Applicant: TOYOTA JIDOSHA KABUSHIKI KAISHA, Toyota-shi (JP)

(72) Inventors: Ibuki SHIMADA, Miyoshi-shi (JP); Koki MORIYA, Nagakute-shi (JP); Hiroki TAKEISHI, Tokyo (JP); Koji UEDA, Funabashi-shi (JP); Ai MIYATA, Osaka (JP)

(73) Assignee: TOYOTA JIDOSHA KABUSHIKI KAISHA, Toyota-shi (JP)

(21) Appl. No.: 18/510,164

(22) Filed: Nov. 15, 2023

(30) Foreign Application Priority Data
Jan. 25, 2023 (JP) 2023-009646

(51) Int. Cl. B60L 53/64; B60L 53/66; G06Q 10/02; G06Q 50/06

(52) U.S. Cl. CPC B60L 53/64; B60L 53/665; G06Q 10/02; G06Q 50/06

(57) ABSTRACT

An information processing method by an information processing device, comprising: receiving from a user terminal a reservation request for reserving that a power feeding source vehicle moves to a power feeding destination vehicle to supply power; determining the characteristic information and estimating the upper limit and the lower limit of the charging rate from the characteristic information, the smaller the difference between the clock time when the power is supplied and the clock time when the reservation request is received, the smaller the difference between the upper limit and the lower limit; and transmitting information indicating the upper limit and the lower limit of the charging fee to the user terminal.

### CROSS-REFERENCE TO RELATED APPLICATION

This application claims priority to Japanese Patent Application No. 2023-009646 filed on Jan. 25, 2023, incorporated herein by reference in its entirety.

### BACKGROUND

### 1. Technical Field

The present disclosure relates to an information processing method.

### 2. Description of Related Art

There conventionally is known a service in which, upon a power feeding request to an own vehicle being made through an app, a power feeding vehicle rushes to the own vehicle and performs power feeding thereto (see, for example, NIO LIMITED, “NIO Power”, [online], 2022, [Retrieved Dec. 14, 2022], Internet <URL: https://www.nio.com/nio-power>).

### SUMMARY

In the related art described above, discrepancy between an estimated charging fee and an actual charging fee sometimes occurs.

An object of the present disclosure, which has been made in view of such circumstances, is to improve the accuracy of estimating charging fees.

An information processing method according to an embodiment of the present disclosure is an information processing method performed by an information processing device, and includes receiving, from a user terminal, a reservation request for making a reservation for a power feeding source vehicle to relocate to a position of a power feeding destination vehicle and to perform power feeding, determining characteristic information related to relocation by the power feeding source vehicle, and estimating an upper limit and a lower limit of a charging fee from the characteristic information, such that the smaller a difference between a clock time at which the power feeding is performed and a clock time at which the reservation request is received is, the smaller a difference between the upper limit and the lower limit is set to be, and transmitting information indicating the upper limit and the lower limit of the charging fee to the user terminal.

According to an embodiment of the present disclosure, the accuracy of estimating charging fees can be improved.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic diagram of an information processing system;

FIG. 2 is a block diagram showing the configuration of an information processing device;

FIG. 3 is a block diagram showing the configuration of each of the user terminal and worker terminal;

FIG. 4 is a flowchart showing the operation of the information processing device;

FIG. 5 is a diagram showing the data structure of the charging fee database (DB); and

FIG. 6 is a diagram showing an example of a screen displayed on the user terminal.

### DETAILED DESCRIPTION OF EMBODIMENTS

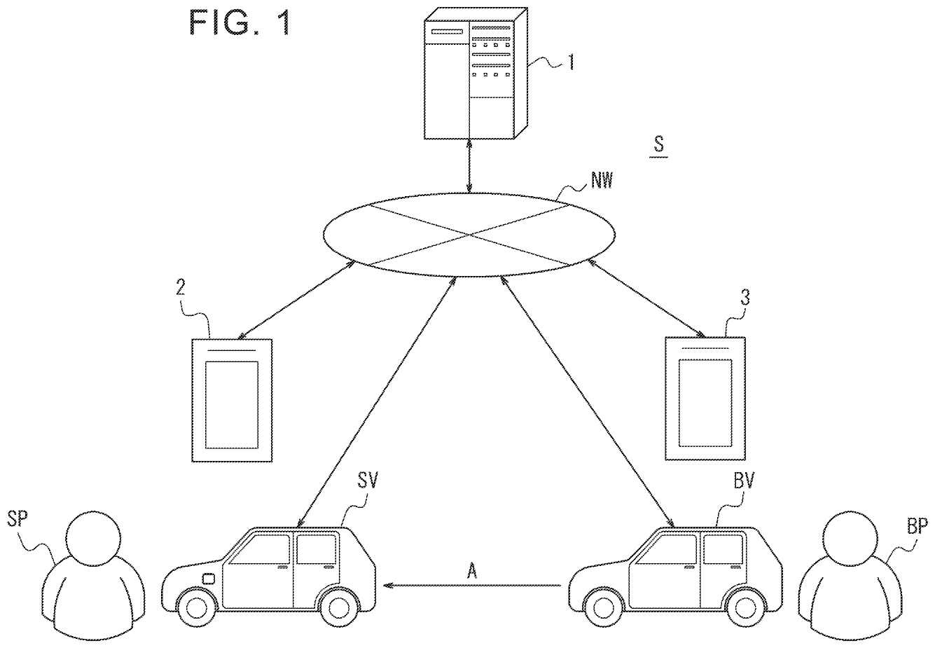

FIG. 1 is a schematic diagram of an information processing system S according to the present embodiment. The information processing system S includes an information processing device 1, a user terminal 2, a worker terminal 3, a power feeding destination vehicle SV, and a power feeding source vehicle BV that can communicate with each other via a network NW. Network NW includes, for example, a mobile communication network, a fixed communication network, or the Internet.

The user terminal 2 is operated by the user SP. The user SP drives the power feeding destination vehicle SV or rides in the power feeding destination vehicle SV. The worker terminal 3 is operated by the worker BP. The worker BP drives the power feeding source vehicle BV or rides in the power feeding source vehicle BV. The power feeding source vehicle BV moves to the position of the power feeding destination vehicle SV as in direction A, and supplies electric power from the power feeding source vehicle BV to the power feeding destination vehicle SV. The movement here is also called rushing. Here, as an example, each of the power feeding destination vehicle SV and the power feeding source vehicle BV is a battery electric vehicle including a battery, but is not limited to this. As an alternative, the user SP does not have to get on the power feeding destination vehicle SV. The worker BP does not have to get on the power feeding source vehicle BV.

For simplicity of explanation, FIG. 1 shows one information processing device 1, one user terminal 2, one worker terminal 3, one power feeding source vehicle BV, and one power feeding destination vehicle SV. However, the numbers of the information processing devices 1, the user terminals 2, and the worker terminals 3 are not limited to this. For example, the processes executed by the information processing device 1 according to the present embodiment may be executed by a plurality of the information processing devices 1 disposed in a distributed manner.

The information processing device 1 is installed in facilities such as a data center. The information processing device 1 is, for example, a computer such as a server belonging to a cloud computing system or other computing systems.

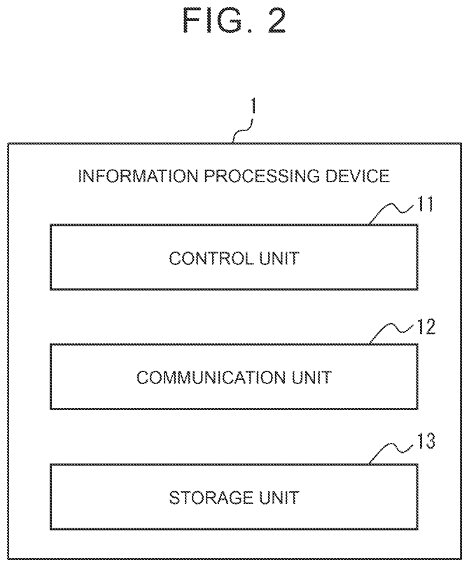

In FIG. 2, the internal configuration of the information processing device 1 will be described in detail.

The information processing device 1 includes the control unit 11, the communication unit 12, and a storage unit 13. The constituent components of the information processing device 1 are connected so as to be able to communicate with each other via a dedicated line, for example.

The control unit 11 includes, for example, one or more general-purpose processors including a Central Processing Unit (CPU) or a Micro Processing Unit (MPU). The control unit 11 may include one or more dedicated processors specialized for a specific process. The control unit 11 may include one or more dedicated circuits instead of including the processor. A dedicated circuit may be, for example, a Field-Programmable Gate Array (FPGA) or an Application Specific Integrated Circuit (ASIC). The control unit 11 may include an Electronic Control Unit (ECU). The control unit 11 transmits and receives information via the communication unit 12.

The communication unit 12 includes a communication module compatible with one or more wired or wireless Local Area Network (LAN) standards for connecting to the network NW. The communication unit 12 may include modules compatible with one or more mobile communication standards including Long Term Evolution (LTE), 4th Generation (4G), or 5th Generation (5G). The communication unit 12 may include a communication module and the like conforming to one or more short-range communication standards or specifications including Bluetooth (registered trademark), Air Drop (registered trademark), infrared data association (IrDA), ZigBee (registered trademark), FeliCa (registered trademark), or radio frequency identifier (RFID). The communication unit 12 transmits and receives information via the network NW.

The storage unit 13 includes a semiconductor memory, a magnetic memory, an optical memory, or a combination of at least two of them. However, the present disclosure is not limited to this. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read-only memory (EEPROM). The storage unit 13 may function as, for example, a main storage device, an auxiliary storage device, or a cache memory. The storage unit 13 may store information on the result of analysis or processing by the control unit 11. The storage unit 13 may store various kinds of information and the like related to the operation or control of the information processing device 1. The storage unit 13 may store a system program, an application program, embedded software, and the like. The storage unit 13 may be provided outside the information processing device 1 and accessed from the information processing device 1. Storage unit 13 includes a charging fee DB.

The user terminal 2 is, for example, a mobile terminal such as a mobile phone, a smart phone, a wearable device, or a tablet. Alternatively, the user terminal 2 may be a general purpose device such as a PC, or a dedicated device. PC is an abbreviation for personal computer.

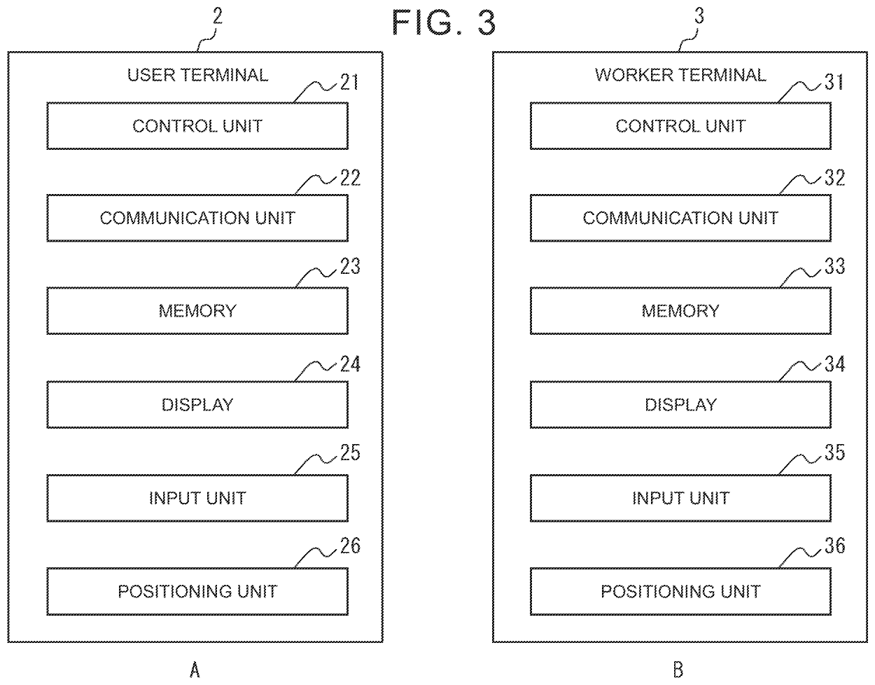

In A of FIG. 3, the internal configuration of the user terminal 2 is explained in detail.

The user terminal 2 includes a control unit 21, a communication unit 22, a storage unit 23, a display unit 24, an input unit 25, and a positioning unit 26. Each component of the user terminal 2 is communicably connected to each other via a dedicated line, for example.

The description of the hardware configuration of the control unit 21, the communication unit 22, and the storage unit 23 of the user terminal 2 may be the same as the description of the hardware configuration of the control unit 11, the communication unit 12, and the storage unit 13 of the information processing device 1. The description here is omitted.

The display unit 24 is, for example, a display. The display is, for example, an LCD or an organic EL display. The term “LCD” is an abbreviation for “liquid crystal display”. EL is an abbreviation for electro luminescence. The display unit 24 may be connected to the user terminal 2 as an external output device instead of being provided in the user terminal 2. As a connection method, for example, any method such as a universal serial bus (USB), a high-definition multimedia interface (HDMI) (registered trademark), or Bluetooth (registered trademark) can be used.

The input unit 25 is, for example, a physical key, a capacitive key, a pointing device, a touch screen integrated with a display, or a microphone. The input unit 25 receives an operation of inputting information used for the operation of the user terminal 2. The input unit 25 may be connected to the user terminal 2 as an external input device instead of being provided in the user terminal 2. As a connection method, for example, any method such as a universal serial bus (USB), a high-definition multimedia interface (HDMI) (registered trademark), or Bluetooth (registered trademark) can be used. The term “USB” is an abbreviation for “universal serial bus”. The term “HDMI (registered trademark)” is an abbreviation for “high-definition multimedia interface”.

Positioning unit 26 includes at least one GNSS receiver. The “GNSS” is an abbreviation for global navigation satellite system. The GNSS includes, for example, at least one of GPS, QZSS, BeiDou, GLONASS, and Galileo. The “GPS” is an abbreviation for global positioning system. The “QZSS” is an abbreviation for quasi-zenith satellite system. A satellite for the QZSS is referred to as a quasi-zenith satellite. GLONASS is an abbreviation for Global Navigation Satellite System. The positioning unit 26 acquires position information. “Positional information” is information that can identify the position of the user terminal 2, and includes coordinates, for example.

In B of FIG. 3, the internal configuration of the worker terminal 3 is explained in detail. The worker terminal 3 includes a control unit 31, a communication unit 32, a storage unit 33, a display unit 34, an input unit 35, and a positioning unit 36. Each component of the worker terminal 3 is connected to each other so as to be able to communicate with each other via, for example, a dedicated line.

The description of the hardware configuration of the control unit 31, the communication unit 32, the storage unit 33, the display unit 34, the input unit 35, and the positioning unit 36 of the worker terminal 3 is given in the control unit 21, the communication unit 22, and the description of the hardware configuration of the storage unit 23, display unit 24, input unit 25, and positioning unit 26 of the user terminal 2 may be the same. The description here is omitted.

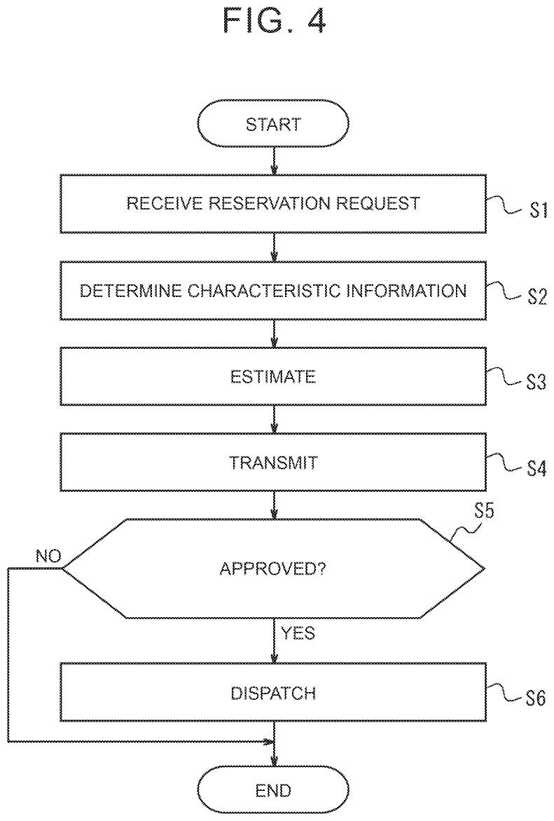

The information processing method by the information processing device 1 will be described in detail below with reference to FIG. 4. Here, as an example, a scene will be described in which the user SP operates the user terminal 2 to make a reservation for power feeding from the power feeding source vehicle BV to the power feeding destination vehicle SV.

In S1, the control unit 11 of the information processing device 1 receives from the user terminal 2 a reservation request for reserving that the power feeding source vehicle BV moves to the power feeding destination vehicle SV and supplies power to the power feeding destination vehicle SV.

In S2, the control unit 11 determines characteristic information related to movement by the power feeding source vehicle BV. The characteristic information is information that affects the charging fee. The characteristic information includes information unique to rush charging. The characteristic information may be acquired from the user terminal 2 or the power feeding destination vehicle SV, or read from the storage unit 13. The characteristic information includes at least one of the following information.
Position indicating the position where power feeding is to be performed
The clock time when the power feeding reservation request was received (e.g., “January 24th 9:00”)
Clock time when power feeding is actually performed (for example, “January 24th 10:00”)
The part of day during which the power feeding destination vehicle SV moves to the position
Vehicle data of power feeding destination vehicle SV
Electricity consumption data of the power feeding destination vehicle SV
Traffic information when moving
Movement route for movement

The part of day during which the movement is performed affects the charging fee. For example, electricity bills are cheaper at night and higher during the day. The labor cost of the worker BP is low during the day and high during the night.

The electricity consumption data of the power feeding destination vehicle SV affects the charging fee. The electricity consumption data may be calculated by the control unit 11 based on, for example, the driving characteristics of the user SP, the mode of use of the power feeding destination vehicle SV, the season, and the like. For example, electricity consumption data fluctuates depending on the driving characteristics of the driver. If the power feeding destination vehicle SV is a rental car, the driver is different depending on the day, so the electricity consumption data will differ depending on the day. Therefore, the electricity consumption data may include electricity consumption data acquired from other vehicles registered in the storage unit 13 in advance by the user SP.

Congestion information during travel affects charging fees. For example, if the power feeding source vehicle BV is stuck in a traffic jam, it takes time to reach the power feeding destination vehicle SV. In this case, the following events may occur.
The power consumption of the power feeding source vehicle BV increases.
The labor cost of the worker BP will increase.
The fuel consumption or electricity consumption of the power feeding source vehicle BV deteriorates.
A series of power feeding plans go wrong (in this case, serviceability deteriorates and sales decrease)
While the user SP is on standby, the battery of the power feeding destination vehicle SV is consumed, and the payment amount increases (in this case, serviceability decreases).

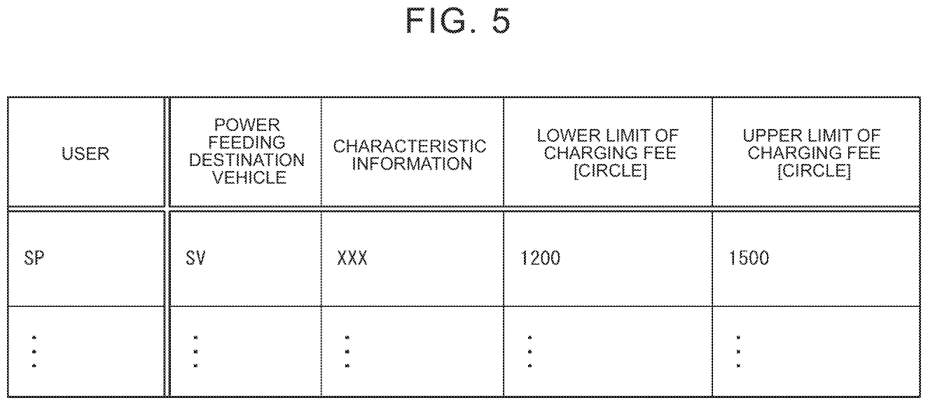

As shown in FIG. 5, the control unit 11 stores the power feeding destination vehicle SV and the characteristic information in the storage unit 13 in association with the user SP.

In S3 of FIG. 4, the control unit 11 estimates the upper limit and lower limit of the charging fee from the characteristic information. The calculation formula for the estimate is arbitrary. In this case, the control unit 11 sets the difference between the upper limit and the lower limit to be smaller as the difference between the clock time when power feeding is actually performed and the clock time when the reservation request is received is smaller. Control unit 11 stores information indicating the upper limit and the lower limit in storage unit 13.

As an additional example or an alternative example, the control unit 11 may determine a plurality of candidates for the positions where the power feeding destination vehicle SV will drop by, and estimate the upper limit and lower limit of the charging fee for each of the plurality of candidates.

As an additional example or alternative, the control unit 11 may estimate the upper limit and lower limit of the charging fee for each of a plurality of travel route candidates. In this case, which one of the multiple candidates is to be adopted may be selected by the user SP at the user terminal 2.

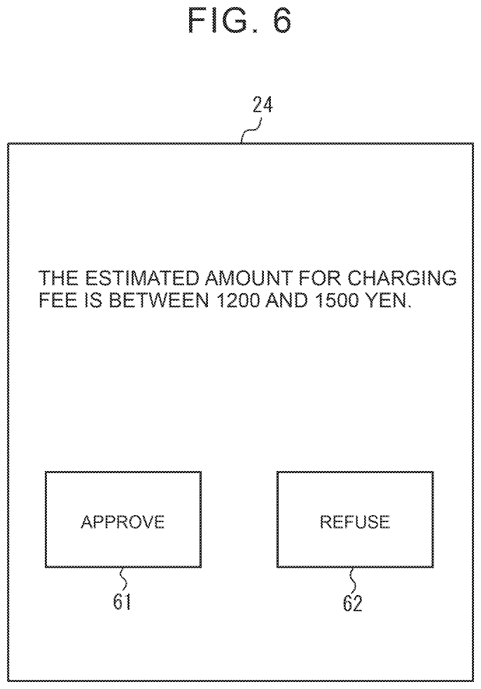

In S4, the control unit 11 transmits to the user terminal 2 information indicating the upper limit and lower limit of the estimated charging fee. FIG. 6 shows an example of the display screen on the display unit 24 in this case. When approving the estimated amount, the user SP selects the icon 61 by tapping or pressing it. The user SP selects the icon 62 when rejecting the estimated amount.

In S5, the control unit 11 determines whether or not the user SP in the user terminal 2 has approved the estimated charging fee. When Yes in S5, the control unit 11 allocates the power feeding source vehicle BV to the position of the power feeding destination vehicle SV in S6. When S5 is No, the control unit 11 terminates the flow of FIG. 4.

As an additional example, the control unit 11 may acquire vehicle data of the power feeding destination vehicle SV immediately before the power feeding is performed, and calculate the charging fee. The control unit 11 may notify the user terminal 2 of both the estimated amount calculated in S3 and the estimated amount calculated immediately before power feeding, and let the user decide which one to select.

As described above, according to the present embodiment, the operation of the control unit 11 of the information processing device 1 is to issue a reservation request for reserving that the power feeding source vehicle BV moves to the power feeding destination vehicle SV to supply power. Receiving from the user terminal 2, determining characteristic information related to movement by the power feeding source vehicle BV, and the difference between the upper limit and the lower limit as the difference between the clock time when power is supplied and the clock time when the reservation request is received is smaller. estimating the upper limit and the lower limit of the charging fee from the characteristic information and transmitting information indicating the upper limit and the lower limit of the charging fee to the user terminal 2 so that the upper limit and the lower limit of the charging fee are set small. With this configuration, the information processing device 1 estimates the charging fee from the characteristic information related to movement, so it is possible to improve the accuracy of estimating the charging fee.

Further, according to the present embodiment, the characteristic information includes at least one of the part of day during which movement is performed, vehicle data of the power feeding destination vehicle SV, electricity consumption data of the power feeding destination vehicle SV, congestion information during movement, and the movement route for movement. With this configuration, the information processing device 1 can further improve the accuracy of estimation.

Further, according to the present embodiment, the characteristic information includes electricity consumption data acquired from other vehicles registered in advance by the user SP. With this configuration, the information processing device 1 can estimate a charging fee that reflects the user SP's normal driving habits, etc., even if the power feeding destination vehicle SV is, for example, a rental car.

Further, according to the present embodiment, the operation of the control unit 11 is to estimate the upper limit and lower limit of the charging fee for each of a plurality of candidates for the travel route for movement, and to transmit the information indicating the upper limit and lower limit of the charging fee for each of the plurality of candidates to the user terminal 2. With this configuration, the information processing device 1 can provide the user SP with room for selection regarding the charging fee, so that serviceability can be improved.

Further, according to the present embodiment, the operation of the control unit 11 includes determining a plurality of candidates for the position where the power feeding destination vehicle SV will drop by, and estimating the upper limit and lower limit of the charging fee for each of the plurality of candidates. With this configuration, the information processing device 1 can give the user SP a choice as to which position to drop by, so serviceability can be improved.

Although the present disclosure has been described above based on the drawings and the embodiment, it should be noted that those skilled in the art may make various modifications and alterations thereto based on the present disclosure. Other changes may be made without departing from the scope of the present disclosure. For example, the functions included in each means or each step can be rearranged so as not to be logically inconsistent. A function or the like included in each means or each step can be combined into one or divided into a plurality of means or steps.

For example, in the above-described embodiments, a program for executing all or part of the functions or processes of the information processing device 1, the user terminal 2, and the worker terminal 3 may be recorded in a computer-readable recording medium. The computer-readable recording medium includes a non-transitory computer-readable medium such as a magnetic recording device, an optical disc, a magneto-optical recording medium, or a semiconductor memory. Programs are distributed by, for example, selling, assigning, or lending a portable recording medium such as a Digital Versatile Disc (DVD) or Compact Disc Read Only Memory (CD-ROM) on which the program is recorded. Further, the distribution of the program may be performed by storing the program in a storage of a server and transmitting the program from the server to another computer. Further, the program may be provided as a program product. The present disclosure can also be realized as a program that can be executed by a processor.

What is claimed is:

1. An information processing method performed by an information processing device, the information processing method comprising:
receiving, from a user terminal, a reservation request for making a reservation for a power feeding source vehicle to relocate to a position of a power feeding destination vehicle and to perform power feeding;
determining characteristic information related to relocation by the power feeding source vehicle;
estimating an upper limit and a lower limit of a charging fee from the characteristic information, such that the smaller a difference between a clock time at which the power feeding is performed and a clock time at which the reservation request is received is, the smaller a difference between the upper limit and the lower limit is set to be; and
transmitting information indicating the upper limit and the lower limit of the charging fee to the user terminal.

2. The information processing method according to claim 1, wherein the characteristic information includes at least one of information indicating a part of day in which the relocation is performed, vehicle data of the power feeding destination vehicle, electricity consumption data of the power feeding destination vehicle, congestion information during the relocation, and information indicating a relocation route for the relocation.

3. The information processing method according to claim 1, wherein the characteristic information includes electricity consumption data acquired from other vehicles registered by a user in advance.

4. The information processing method according to claim 1, further comprising:
estimating an upper limit and a lower limit of the charging fee for each of a plurality of candidates for a relocation route for the relocation; and
transmitting, to the user terminal, information indicating the upper limit and the lower limit of the charging fee for each of the candidates.

5. The information processing method according to claim 1, further comprising:
determining a plurality of candidates for drop-by positions for the power feeding destination vehicle to drop by; and
estimating an upper limit and a lower limit of the charging fee for each of the candidates.
